(19) United States
(12) Patent Application Publication
(10) Pub. No.: US 2016/0264038 A1
(43) Pub. Date: Sep. 15, 2016

(54) MAT AND CHOCK SYSTEM

(71) Applicants: Timothy H. Parkes, Chattanooga, TN (US); Johnny Lamar Brown, Chattanooga, TN (US); Diner Mondragón, Dalton, GA (US); Annette Marie Stroud, Chattanooga, TN (US)

(72) Inventors: Timothy H. Parkes, Chattanooga, TN (US); Johnny Lamar Brown, Chattanooga, TN (US); Diner Mondragón, Dalton, GA (US); Annette Marie Stroud, Chattanooga, TN (US)

(73) Assignee: Remington Industries, Ooltewah, TN (US)

(21) Appl. No.: 15/068,494

(22) Filed: Mar. 11, 2016

Related U.S. Application Data
(60) Provisional application No. 62/132,294, filed on Mar. 12, 2015.

(51) Int. Cl. B60P 7/135; F16M 11/22

(52) U.S. Cl. CPC B60P 7/135; F16M 11/22

(57) ABSTRACT

A floor mat system has chock-receiving features and one or more chocks engageable with those features. The chocks are shaped or adapted to engage one or more of a variety of articles, to thereby secure the articles to the floor mat in a customizable arrangement.

### RELATED APPLICATION

This application claims benefit to and is a formalization of U.S. Provisional Application No. 62/132294 filed on 12 Mar. 2015. The teachings thereof are incorporated herein in their entirety by reference.

### FIELD OF THE INVENTION

The present invention is related to mats. More specifically, the present invention is related to a floor mat system having an array of chock-receiving features and one or more chocks. The chocks are engageable with those features and are shaped or adapted to engage one or more of a variety of articles, to thereby secure the articles to the floor mat in a customizable arrangement. The mat may be provided in any of a variety of shapes to conform to such specific uses as automotive, home storage, or in the workplace.

### BACKGROUND

Floor mats are commonly used to rest articles upon, such as during transportation and storage. The mats are typically used to prevent slipping of the article, to provide protection of the article from the underlying floor, and to protect the underlying floor from the article. Mats made of non-slip materials or in a non-slip configuration are often employed in vehicles, such as in the beds of pick-up trucks and in the backs of SUVs, to prevent goods being transported from sliding around during travel. Such mats typically depend on gravity in combination with the non-slip mat surface to prevent sliding, and some mats include features specifically shaped and arranged to receive a specific article in a specific location on the mat and to prevent that article from slipping from that location. Existing mats are also often used in cooperation with additional security such as ropes or tethers.

Chocks are a familiar device for retaining articles and vehicles in place against slipping or rolling. Most commercial trucks carry at least one pair of chocks to place on the ground in front of or behind the wheels when the truck breaks down on inclined roadways or when the truck docks at a loading platform, to prevent it from rolling. The chocks are typically wedge-shaped with a flat bottom surface to engage the ground, and have an inclined flat or inclined concave surface to engage the tire of the vehicle. The chock is typically wedged between the ground and tire on the downhill side of the tire so that the truck's tendency to roll downhill will be prevented.

There exists a need for a customizable mat and chock system for storing or transporting a variety of articles in customizable fashion, and such is an object of the present invention. There exists a need for engaging an article securely with one or more chocks, and for securing the chocks in a desirable and fixed position and location to thereby secure the article in a desirable and fixed position and location, and such is an object of the present invention. There exists the need for a mat and chock system having one or more chocks shaped and sized according to anticipated articles to provide the most secure engagement thereto in a customizable fashion, and such is an object of the present invention. There exists the need to couple the chocking of the article with the mat to protect the article and the floor underneath it and to further retain the article in a desirable and fixed position and location, and such is an object of the present invention. There exists the need for a mat and chock system that includes a variety of differently shaped and configured chocks to allow selection of a chocking arrangement that most securely receives any particular article, or a multitude of similar or different articles, and such is an object of the present invention. There is a need for a mat having an array of features for receiving and securing the chocks and to support one or more articles in non-slip fashion, to reduce the need for and dependency on ropes and tethers, and such is an object of the present invention. There exists a need for such mat and chock systems that are shaped and adapted to conform to specific vehicles and vehicle types. Further needs and objects exist which are addressed by the present invention, as may become apparent by the included disclosure of an exemplary embodiment thereof.

### SUMMARY OF THE INVENTION

The invention may be embodied in or practiced using a mat and chock system including one or more mats and one or more chocks. The one or more mats may be joinable together in a variety of arrangements to form a larger mat, may be used individually, or may be cut to a desired shape. The one or more mats may include an array of receivers for receiving the one or more chocks in a variety of selectable positions and orientations. The joining of the one or more mats may be accomplished using fasteners which include features for affixation of the fasteners to the receivers of adjacent mats. The one or more chocks may include features on their bottom sides for temporary or permanent affixation of the chocks to the receivers of the one or more mats in the selectable positions and orientations. The one or more chocks may include a multitude of faces, each having a specialized shape for engaging one or more types of articles to be prevented from sliding or falling when set on the mat and engaged by the one or more chocks in the selected positions and orientations. The mat system may be used in a variety of locations such as residences, businesses, and vehicles. The mats may also be used independently, without the chocks, then desired, such as to provide an anti-slip and anti-fatigue surface for users to walk or stand upon.

The invention may be embodied in or practiced using, in combination, a mat and one or more chocks for rigidly positioning an article on the mat. The mat may have a planar upper surface having thereon an array of equally-rectilinearly-spaced chock receivers. Each of the one or more chocks may have one or more chock locators and one or more article locators. The one or more chock locators may each be a feature disposed on the underside of an associated one of the one or more chocks adapted to fixedly mate with the chock receivers so that the associated one of the one or more chocks is secured to the mat at a selectable chock position according to a selection of a particular one or more of the chock receivers. The one or more article locators may each be a surface or feature contoured to engage a surface or feature of the article so that the article is secured against the chock and there-through rigidly positioned on the mat at a selectable article position according to the selection of the particular one or more of the chock receivers.

The chock receivers may include vertically-directed holes into or through the mat. The chock locators may include downwardly-depending posts adapted for mating with the holes. The article locators may include one or more of the group including; a flat vertical surface, a linearly concave surface, a linearly convex surface, a spherically concave surface, a spherically convex surface, an inside corner, and an outside corner.

The invention may alternatively be embodied in or practiced using a mat for use with one or more chocks to position an article rigidly thereon. The mat may have a planar upper surface having thereon an array of equally-rectilinearly-spaced chock receivers. The chock receivers may be adapted for fixedly mating with one of the one or more chocks to secure the one of the one or more chocks to the mat at a selectable chock position according to a selection of a particular one or more of the chock receivers. The chock receivers may include vertically-directed holes into or through the mat.

The invention may alternatively be embodied in or practiced using a chock for rigidly positioning an article on a mat. The chock may have one or more chock locators and one or more article locators. The one or more chock locators may each include a feature disposed on the underside of the chock adapted to fixedly mate with the mat to secure the chock to the mat. The one or more article locators may each include a surface or feature contoured to engage a surface or feature of the article so that the article is secured against the chock and there-through rigidly positioned on the mat. The chock locators may include downwardly-depending posts. The article locators may include one or more of the group including; a flat vertical surface, a linearly concave surface, a linearly convex surface, a spherically concave surface, a spherically convex surface, an inside corner, and an outside corner. The one or more article locators may be a plurality of article locators, each disposed on a different one of the sides and/or top of chock, and each including one or more of the group including; a flat vertical surface, a linearly concave surface, a linearly convex surface, a spherically concave surface, a spherically convex surface, an inside corner, and an outside corner.

Further features and aspects of the invention are disclosed with more specificity in the detailed description and drawings provided herein.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

The system and exemplary embodiments employing the system are shown in the accompanying drawings and illustrations, of which;

FIG. 1A is a plan view a small rectangular mat for use in a mat system according to a first embodiment;

FIG. 1B is a plan view a large rectangular mat for use in a mat system according to a second embodiment;

FIG. 1C is a plan view a specially-shaped mat for use in a mat system according to a third embodiment;

FIG. 2 is top perspective view of the mat of FIG. 1B;

FIG. 3 is bottom perspective view of the mat of FIG. 1B, showing its reversibility;

FIG. 4 is bottom perspective view of a ganged arrangement of several of the mats of FIG. 1A;

FIG. 5 is top perspective view of a ganged arrangement of several of the mats of FIG. 1A;

FIG. 6 is a perspective view of a L/R pair of chocks for use with the mats of FIGS. 1A through 1C;

FIG. 7 is a bottom perspective view of one of the chocks of FIG. 6;

FIG. 8 is a perspective view showing one of the chocks of FIG. 6 used in conjunction with the one of the mats of FIGS. 1A through 1C for securing an article from sliding;

FIG. 9A is a left perspective view of a workbench affixed to the upright mat of FIG. 1B by the left/right pair of the chocks of FIG. 6;

FIG. 9B is a right perspective view of the workbench of FIG. 9A affixed to the flipped-over mat of FIG. 1B by the left/right pair of the chocks of FIG. 6;

FIG. 10 is a view of the mat of FIG. 1B used with the L/R pair of chocks of FIG. 6 to provide an automobile locating system for use in a garage;

FIG. 11 is a view of the mat of FIG. 1B used with two pairs of the chocks of FIG. 6 to secure articles in the back of an automobile;

FIG. 12 is a view of the mat of FIG. 1B used with a pair of the chocks of FIG. 6 to secure a ladder in the bed of a pick-up truck;

FIG. 13 is a view of the mat of FIG. 1A used with a pair of the chocks of FIG. 6 to secure a recreational vehicle in the bed of a pick-up truck;

FIG. 14 is a perspective view of a barbeque grill and propane tank affixed to the mat of FIG. 1B by two of the L/R pairs of the chocks of FIG. 6;

FIG. 15 is a perspective view of the mat of FIG. 1B used with a L/R pair of the chocks of FIG. 6 to position a tractor; and

FIG. 16 is a perspective view of the mat of FIG. 1B used with two L/R pairs of the chocks of FIG. 6 to secure articles in a boat.

### DETAILED DESCRIPTION

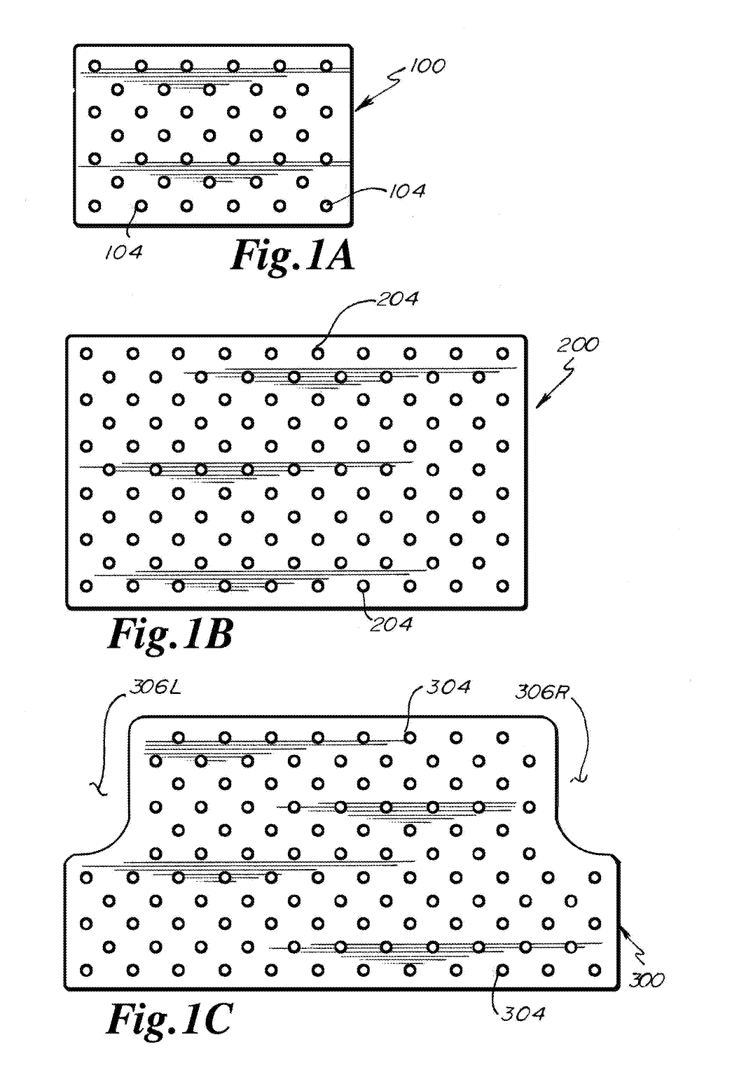

Reference is first made to FIGS. 1A through 7 where, the disclosed exemplary embodiments depict a mat and chock system using one or more mats and one or more chocks affixable thereto in a multitude of selectable temporary or permanent positions and orientations, for securing an infinite variety of variously shaped articles against sliding and such. The one or more mats may alternatively be used singly or affixed together and used independent of the chocks to provide an anti-slip and anti-fatigue surface. Referring first to FIGS. 1A through 1C, three mats of different sizes and shapes are shown; the first mat 100 having dimensions of twenty-four by thirty-six inches, the second mat 200 having dimensions of thirty-six by sixty inches, and the third mat 300 having dimensions of thirty-six by seventy-two inches and having wheel-well cutouts 306 R/306L to fit within the bed of a pick-up truck or back of an SUV. The system is thereby available for a variety of locations and uses. Many other sizes and shapes are also possible.

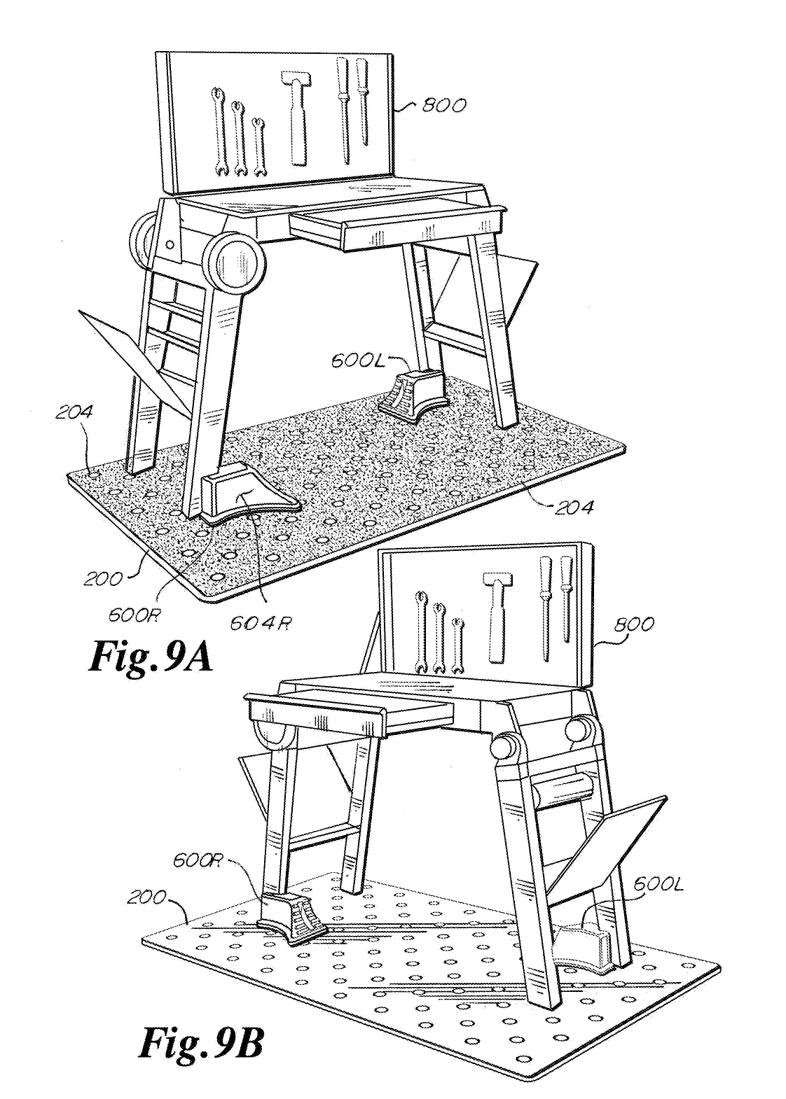

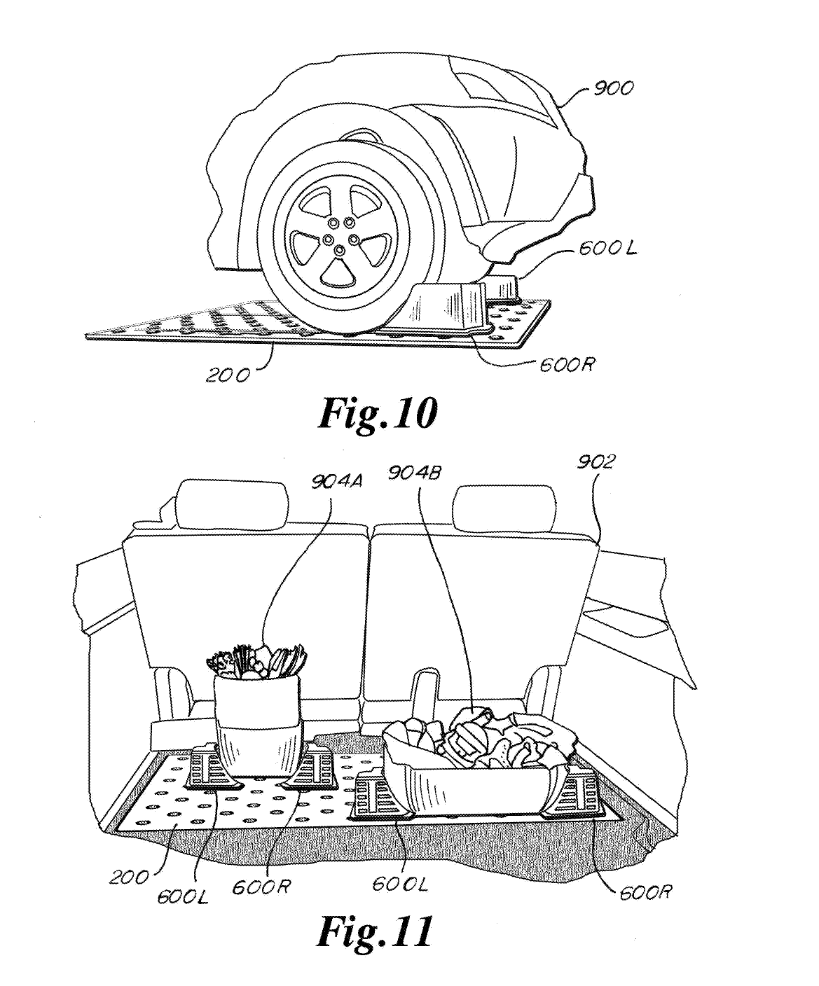

The thickness of the mats may range from one-quarter of an inch to one inch, depending on the material and intended use. The material of the mats may be rubber or foam rubber, or any suitable material including any material known for use in anti-slip and anti-fatigue matting. The durometer of the material may be selected according to the intended use. For instance, for one version intended for use in locating vehicles within a garage, such as shown in FIG. 10, a harder durometer may be desirable. While another version intended for use for a mat to both secure a workbench and provide anti-fatigue comfort to a user standing at the workbench, such as shown in FIGS. 9A and 9B, may better use a softer durometer material.

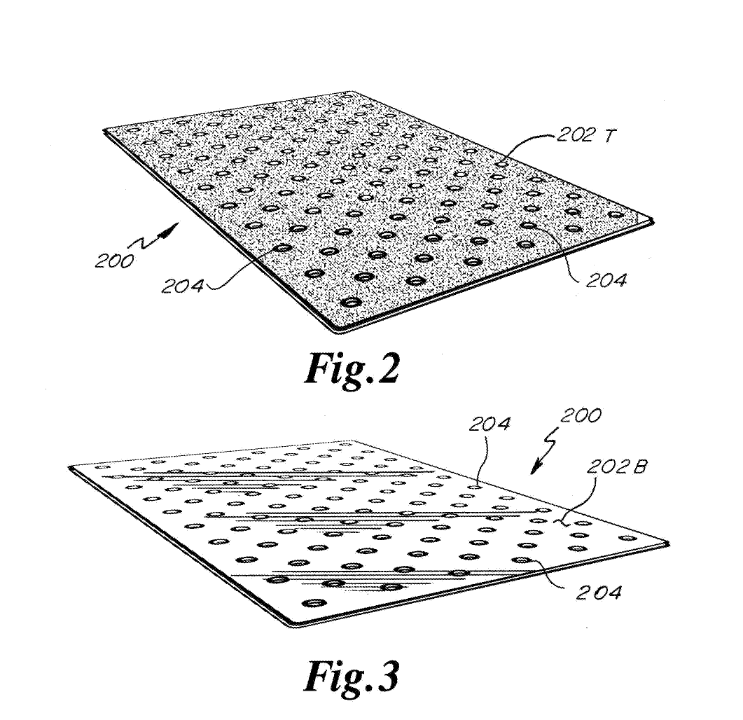

As shown in FIGS. 2 and 3, the mats 200 may be reversible, having top 202T and bottom 202B surfaces with different qualities. One side may be smoother and more comfortable to stand on and provide better anti-fatigue properties (FIG. 3), while the other may be rougher to provide better traction against slipping or for foot-scraping (FIG. 2). The mat may also be laminated or otherwise formed of two layers having different durometers or of different materials to provide more flexibility of use. One side may be softer for top-side use as an anti-fatigue or walk-off mat, which the other side may be harder for supporting heavier items without being damaged. Alternatively, the mat may not be reversible and may only have one dedicated top surface. The top and bottom surfaces are both preferably slip-preventing, either by surface texture or material properties; the top side being such to prevent people or articles from moving relative to the mat, and the underside being such to prevent movement of the mat relative to the supporting surface, such as the bed of a moving pick-up truck.

It can be seen in any of FIGS. 1A through 3 that the mats have arrays of holes 104/204/304 forming chock receivers. These receivers are equally spaced on a rectilinear grid pattern, but may alternatively be disposed in a more specific pattern for a specific use. These receivers are shown as round holes, but may be alternatively shaped holes, slots, or equivalent features. The receivers are shown as through-holes because they perform as receivers in the depicted reversible mats regardless of the top/bottom position of the mats, but if the mats were of a nonreversible type, the holes could be blind to prevent debris from falling there-through. The mat surfaces may also include grooves such as for collecting or shedding rain and spilled liquids.

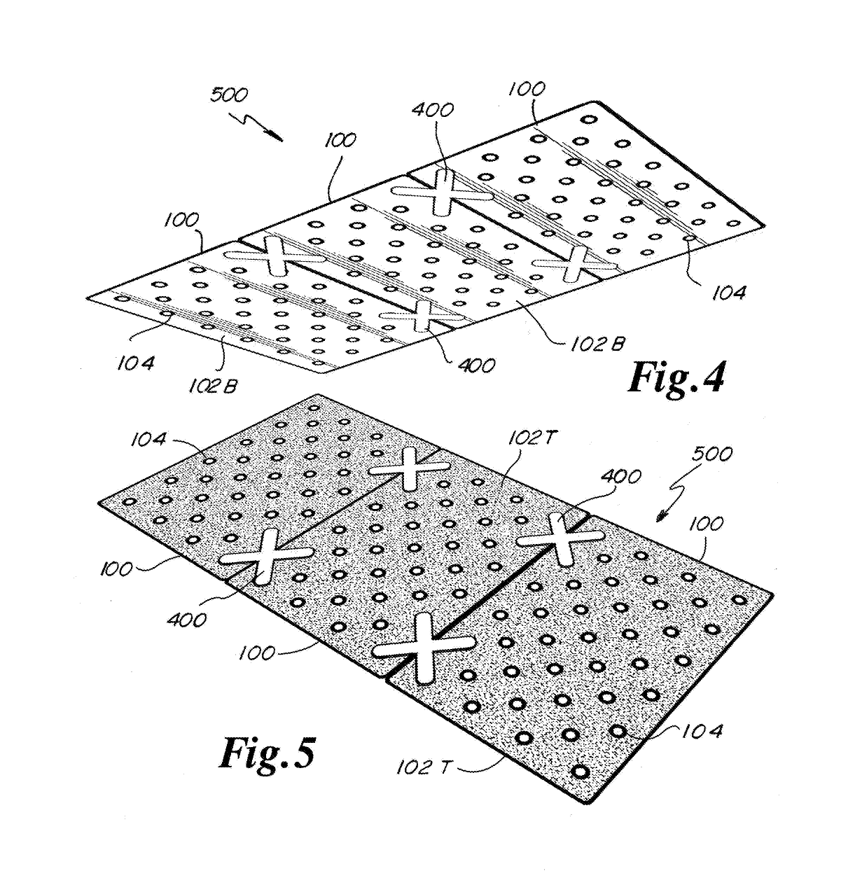

Referring to FIGS. 4 and 5, it can be seen that a plurality of the mats 200 of FIG. 1A (or 1B) may be affixed together using fasteners such as the X-shaped fasteners 400 shown. These fasteners could be affixed either to the underside or top side of the adjacent mats, having features (not shown) similar to those on the chocks (to be shown and described herein) to fit into the chock receivers, to permanently or temporarily secure the mats relative to each other. It should be appreciated that a larger mat 500 can thereby be created, having a virtually infinite number of possible overall sizes or shapes. Mats of various sizes such as shown in FIG. 1A and 1B may be joined. They may be joined linearly, rectangularly, or in patterns such as to follow around corners or through meandering hallways. The mats may also be cut to any desired shape. For instance, if a mat is to be used in the bed of a pick-up truck, the user may trim wheel-well cutouts 306R/306L out of the sides of the mat to avoid the truck's wheel-wells, as shown in FIG. 1C.

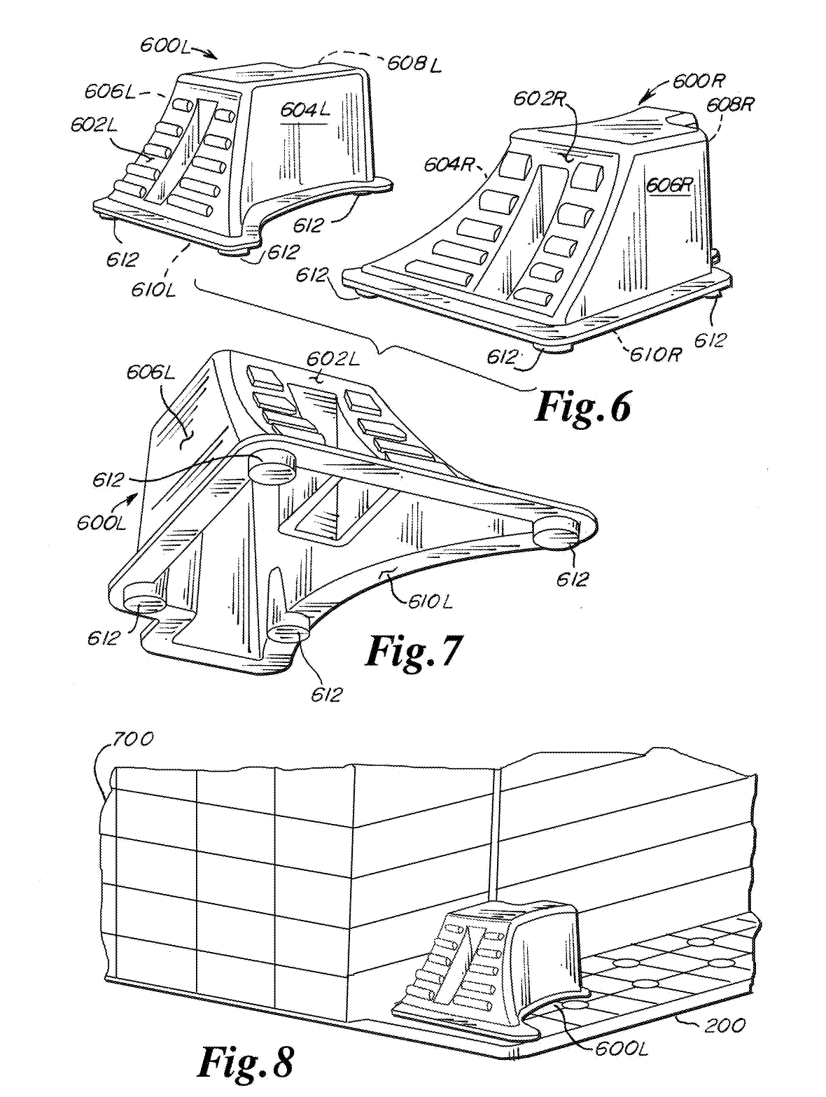

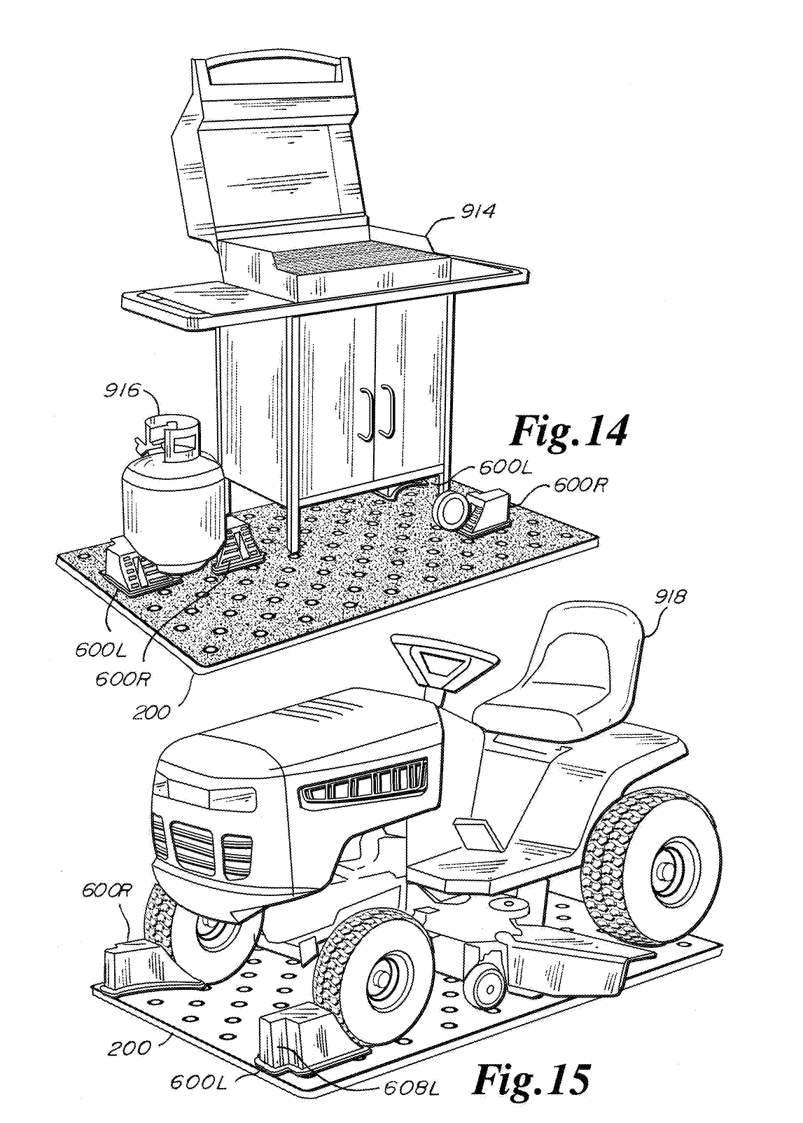

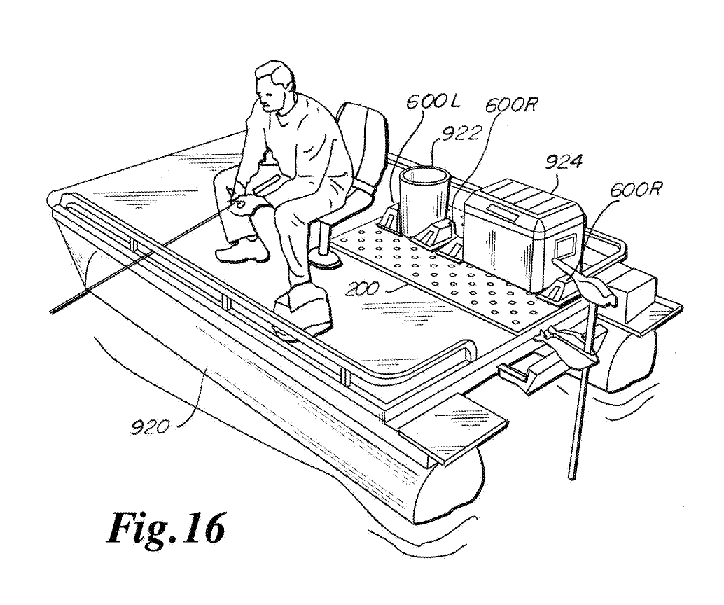

Referring to FIGS. 6 and 7, there are shown exemplary chocks 600L/600R for use with the system. The chocks are shown as a pair of left and right mirror-image configurations, each having a variety of top and side faces shaped to interact with a variety of articles which the system may be used to secure. But the chocks may be alternatively shaped; for instance, a variety of chocks may be provided each intended for interfacing with a different article. Or chocks may be provided with some unique shape for mating to a specific article. As shown, a first side 602R/602L of each of the left and right chocks has an upwardly concave shape to provide such functions as interfacing with vehicle wheels (FIGS. 10, 13, and 15), or with articles having rounded bottoms (FIG. 11). A second side 604R/604L has a vertically curved shape to interact with upstanding cylinders and such (FIGS. 14 and 16). A third side 606R/606L is flat to interact with flat articles and surfaces (FIGS. 8, 12, and 16). And a fourth side 608R/608L is stepped-in (L-shaped) to capture the corners or legs of articles (FIG. 9).

Referring to FIG. 7, the bottom 610R/610L of the chocks includes locating features 612 for engaging the chock receivers 104/204/304 of the mats 100/200/300. These features are embodied herein as downwardly-depending round posts 612 which fit into the round holes 104/204/304 of the mats and prevent side-to-side movement of the chock relative to the mat, but may have another shape according to the shape of the receivers of the mat. As embodied, the chocks are held to the mat by gravity and a snug fit of the posts into the holes, but the fastening arrangement could be made more secure if desired, such as a snap-in, a seizing-taper, or a press-fit arrangement. The X-shaped fasteners 400 that hold adjacent mats together as in FIG. 5 use similar or identical features as the chocks for engaging the mat holes.

FIG. 8 shows a cubic article 700, such as a box, being secured against sliding on mat 200 by the flat third face 606L of chock 600L snugged against a flat face of the article.

FIGS. 9A and 9B show a work bench 800 being secured on mat 200 by the step-ins of the L-shaped fourth sides 608R/608L of chocks 600R/600L grasping the legs of the bench, leaving room on the mat for a user to stand while working at the bench.

In FIG. 10, the upwardly-curved first faces 602R/602L of a pair of chocks 600R/600L cooperate with mat 200 in a drive-on configuration to provide a location indicator for automobile 900. The driver simply drives unto the mat until his tires are stopped by the chocks and he knows his car is perfectly positioned in his garage.

FIG. 11 shows articles 904A/904B being secured in the rear compartment of an SUV 902 using two pairs of chocks 600R/600L and mat 200. The articles may be dedicated baskets shaped specifically to mate with the horizontally-curved faces of the chocks, for holding other articles such as shopping bags and loose items, or the articles may be the shopping bags and loose articles themselves.

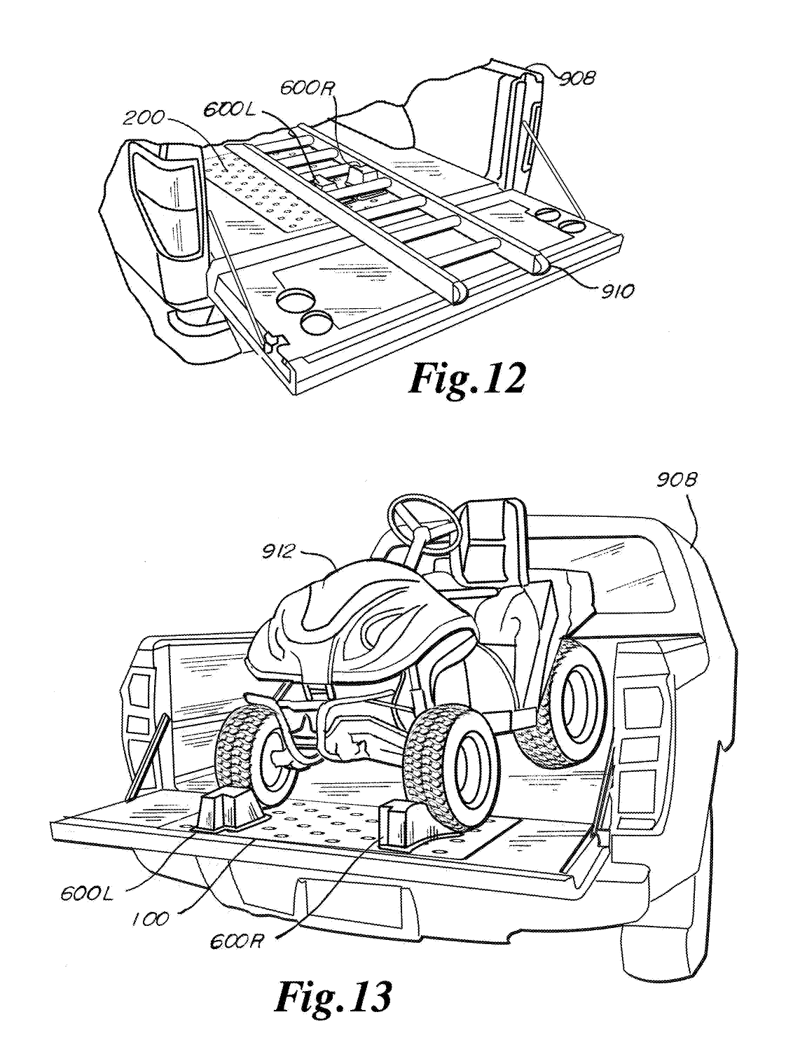

FIG. 12 shows mat 200 in the bed of a pick-up truck 908 having a pair of chocks 600R/600L positioned to fit between the rungs and rails of a ladder 910 to secure it from sliding as the truck moves. Another pair of chocks may optionally be similarly placed further forward to further secure the ladder.

FIG. 13 shows mat 100 on the tailgate of pick-up truck 908 having the upawrdly-curved faces 602R/602L of a pair of chocks 600R/600L positioned to secure the tires of a recreational vehicle 912 in the bed of the truck. The recreational vehicle may either be pushed firmly against the cab of the truck or else another pair of oppositely-facing chocks my secure the opposite pair of its tires.

FIG. 14 shows two pairs of chocks 600R/600L securing a barbecue grill 914 and a propane tank 916 to mat 200, leaving room on the mat for the user to stand while cooking. The vertically-curved faces 604R/604L of one pair of the chocks secure the cylindrical propane tank while the upwardly-curved faces 602R/602L of the other pair secure the wheels of the grill. It should be appreciated that this arrangement not only secures these hazardous articles independently to prevent dangerous individual movement, but also secures them together to prevent dangerous movement relative to each other.

FIG. 15 shows a tractor 918 secured to or located on mat 200 by the upwardly-curved faces 602R/602L of chocks 600R/600L interfacing with the tractor's front tires to prevent forward rolling. An additional pair of chocks could be similarly used to secure the rear tires to prevent rearward rolling.

And FIG. 16 shows a bait bucket 922 and a cooler 924 being similarly secured by this mat/chock system in a boat 920.

While the invention has been shown and described with reference to specific exemplary embodiments, it should be understood by those skilled in the art that various changes in form and detail may be made without departing from the spirit and scope of the invention, and that the invention should therefore only be limited by the following claims, including all equivalent interpretation to which they are entitled.

We claim:

1. In combination, a mat and one or more chocks for rigidly positioning an article on the mat:
the mat comprising a planar upper surface having thereon an array of equally-rectilinearly-spaced chock receivers; and
each of the one or more chocks comprising one or more chock locators and one or more article locators; wherein
the one or more chock locators each comprises a feature disposed on the underside of an associated one of the one or more chocks adapted to fixedly mate with the chock receivers so that the associated one of the one or more chocks is secured to the mat at a selectable chock position according to a selection of a particular one or more of the chock receivers, and
the one or more article locators each comprises a surface or feature contoured to engage a surface or feature of the article so that the article is secured against the chock and there-through rigidly positioned on the mat at a selectable article position according to the selection of the particular one or more of the chock receivers.

2. The combination of claim 1 wherein the chock receivers comprise vertically-directed holes into or through the mat.

3. The combination of claim 2 wherein the chock locators comprise downwardly-depending posts adapted for mating with the holes.

4. The combination of claim 1 wherein the chock locators comprise downwardly-depending posts.

5. The combination of claim 4 wherein the article locators comprise one or more of the group comprising; a flat vertical surface, a linearly concave surface, a linearly convex surface, a spherically concave surface, a spherically convex surface, an inside corner, and an outside corner.

6. The combination of claim 1 wherein:
the article locators comprise one or more of the group comprising; a flat vertical surface, a linearly concave surface, a linearly convex surface, a spherically concave surface, a spherically convex surface, an inside corner, and an outside corner;
the chock receivers comprise vertically-directed holes into or through the mat; and
the chock locators comprise downwardly-depending posts adapted for mating with the holes.

7. A mat for use with one or more chocks to position an article rigidly thereon, the mat comprising a planar upper surface having thereon an array of equally-rectilinearly-spaced chock receivers, each adapted for fixedly mating with one of the one or more chocks to secure the one of the one or more chocks to the mat at a selectable chock position according to a selection of a particular one or more of the chock receivers.

8. The combination of claim 7 wherein the chock receivers comprise vertically-directed holes into or through the mat.

9. A chock for rigidly positioning an article on a mat, the chock comprising one or more chock locators and one or more article locators; wherein the one or more chock locators each comprises a feature disposed on the underside of the chock adapted to fixedly mate with the mat to secure the chock to the mat, and
the one or more article locators each comprises a surface or feature contoured to engage a surface or feature of the article so that the article is secured against the chock and therethrough rigidly positioned on the mat.

10. The chock of claim 9 wherein the chock locators comprise downwardly-depending posts.

11. The chock of claim 10 wherein one or more the article locators each comprises one or more of the group comprising; a flat vertical surface, a linearly concave surface, a linearly convex surface, a spherically concave surface, a spherically convex surface, an inside corner, and an outside corner.

12. The chock of claim 9 wherein the one or more article locators each comprises one or more of the group comprising; a flat vertical surface, a linearly concave surface, a linearly convex surface, a spherically concave surface, a spherically convex surface, an inside corner, and an outside corner.

13. The chock of claim 9 wherein the one or more article locators comprise a plurality of article locators, each disposed on a different one of the sides and/or top of chock, and each comprising one or more of the group comprising; a flat vertical surface, a linearly concave surface, a linearly convex surface, a spherically concave surface, a spherically convex surface, an inside corner, and an outside corner.
